(19) United States
(12) Patent Application Publication
(10) Pub. No.: US 2014/0339837 A1
(43) Pub. Date: Nov. 20, 2014

(54) Modular Front End System And Related Components

(71) Applicant: Pronghorn Overland Gear LLC, Boerne, TX (US)

(72) Inventor: Robert Charles Hermann, III, Boerne, TX (US)

(21) Appl. No.: 14/280,525

(22) Filed: May 16, 2014

Related U.S. Application Data
(60) Provisional application No. 61/824,329, filed on May 16, 2013.

(51) Int. Cl. B60R 19/34; B60R 19/48; B60R 19/52

(52) U.S. Cl. CPC B60R 19/34; B60R 19/52; B60R 19/48; B60R 2019/527
USPC 293/115; 293/133; 293/117

(57) ABSTRACT

A modular front end system includes a main bumper structure, outer bumper structures disposed on either end of the main bumper structure, and tension plates disposed at junctions between the main bumper structure and each of the outer bumper structures and supportably coupling each outer bumper structure to the main bumper structure, wherein each tension plate is configured to fail before the main bumper structure and the outer bumper structures in the event of a collision.

### CROSS-REFERENCE TO RELATED APPLICATIONS

This application claims priority under 35 U.S.C. §119(e) to U.S. Provisional Application No. 61/824,329, filed May 16, 2013, which is incorporated herein by reference in its entirety.

### FIELD

Embodiments disclosed herein relate to the field of off-roading, and specifically to a modular front end system and related components for use with off-road vehicles.

### BACKGROUND

Off-roading is the recreation of driving or riding a vehicle on un-surfaced roads or tracks made of materials such as sand, gravel, riverbeds, mud, snow, rocks or other natural terrain. In most cases off-road terrains may only be traveled by vehicles designed specifically for off-road driving such as all-terrain vehicles (“ATVs”), heavy-duty pickup trucks, trucks and equipment, sport utility vehicles (“SUVs”), snowmobiles, motorcycles or mountain bikes. These types of vehicles often have extra ground clearance, sturdy tires, and front and rear locking differentials, and low gearing. Many manufacturers make specialized vehicles for off-roading, like trucks and 4×4 vehicles.

### SUMMARY

In one aspect, embodiments disclosed herein relate a modular front end system including a main bumper structure, outer bumper structures disposed on either end of the main bumper structure, and tension plates disposed at junctions between the main bumper structure and each of the outer bumper structures and supportably coupling each outer bumper structure to the main bumper structure, wherein each tension plate is configured to fail before the main bumper structure and the outer bumper structures in the event of a collision.

In other aspects, embodiments disclosed herein relate to a vehicular front end system including a main bumper and separate modular outer bumper components, one or more tension plates configured to supportably couple the modular outer bumper components to the main bumper, wherein the tension plates are configured to fail before the main bumper and modular outer bumper components in the event of a collision, a plurality of modular plate components coupled to the main bumper having one or more grill guards extending therebetween, and headlight guards configured as cantilevered ends which are joined to the modular plate components, wherein the cantilevered ends of the headlight guards are configured to distribute impact loads during a collision across the modular plate components.

In yet other aspects, embodiments disclosed herein relate to a gear mount system including a mounting leg inserted into at least one mounting point in a vehicle or bumper, a plurality of tensioners each having a hole through which the mounting leg is inserted, wherein each tensioner comprises a first width defined between a first planar surface and a second planar surface, and a second width defined between the first planar surface and a recessed surface, wherein the first width is greater than the second width, and a retaining pin configured to be inserted at an end of the mounting leg, wherein after the retaining pin is inserted, the plurality of tensioners are configured to be rotated about an axis of the mounting leg to abut the second planar surfaces of the plurality of tensioners and impart tension on the mounting leg.

In still further aspects, embodiments disclosed herein relate to a rotator shackle assembly including a rotator sleeve having a central axial bore, annular flanges on both ends, and a passageway extending through a diameter of the rotator sleeve in a direction perpendicular to the axial bore, a rotator pin having a generally cylindrical stem portion extending from a head portion, and a groove extending circumferentially about the stem portion, a retainer pin having a generally cylindrical stem portion extending from a head portion, wherein the rotator pin is inserted into the axial bore until the circumferential groove is substantially aligned with the passageway in the rotator sleeve, and wherein the retainer pin is inserted into the passageway of the rotator sleeve and engages the circumferential groove of the rotator pin.

In other aspects, embodiments disclosed herein relate to a hi-lift shackle including a pin configured to be inserted into a corresponding receptacle in the main bumper or outer bumper structures and at least two shackle plates comprising tongues inserted in opposite directions through the pin, wherein the at least two shackle plates are coupled together.

### BRIEF DESCRIPTION OF THE FIGURES

FIGS. 1A and 1B illustrate perspective views of a Modular Front End System.

FIGS. 2A and 2B illustrate a tension plate used with the MFES.

FIG. 3A illustrates a gear mount system.

FIG. 3B illustrates gear mount point.

FIG. 3C illustrates an exploded view of the gear mount system of FIG. 3A.

FIG. 3D illustrates female mounting cones of the gear mount system.

FIG. 3E illustrates a tensioner component of the gear mount system of FIG. 3C.

FIG. 3F illustrates tensioners of the gear mount system in an unlocked position.

FIG. 3G illustrates tensioners of the gear mount system in a locked position.

FIGS. 3H-3J illustrate a winch accessory coupled with the gear mount system.

FIG. 4A illustrates an exploded perspective view of a rotator shackle assembly.

FIGS. 4B-4E illustrate method steps in assembling the rotator shackle assembly.

FIGS. 4F-4I illustrate exemplary positions of a recovery shackle coupled to the rotator shackle assembly.

FIG. 5A illustrates a hi-lift shackle assembly.

FIG. 5B illustrates an exploded view of the hi-lift shackle assembly of FIG. 5A.

FIG. 6A illustrates a drop pin jaw.

FIG. 6B illustrates a drop pin.

FIG. 6C illustrates a drop pin jaw assembly.

FIGS. 6D-6F illustrates method steps in attaching a recovery device with the drop pin jaw assembly.

### DETAILED DESCRIPTION

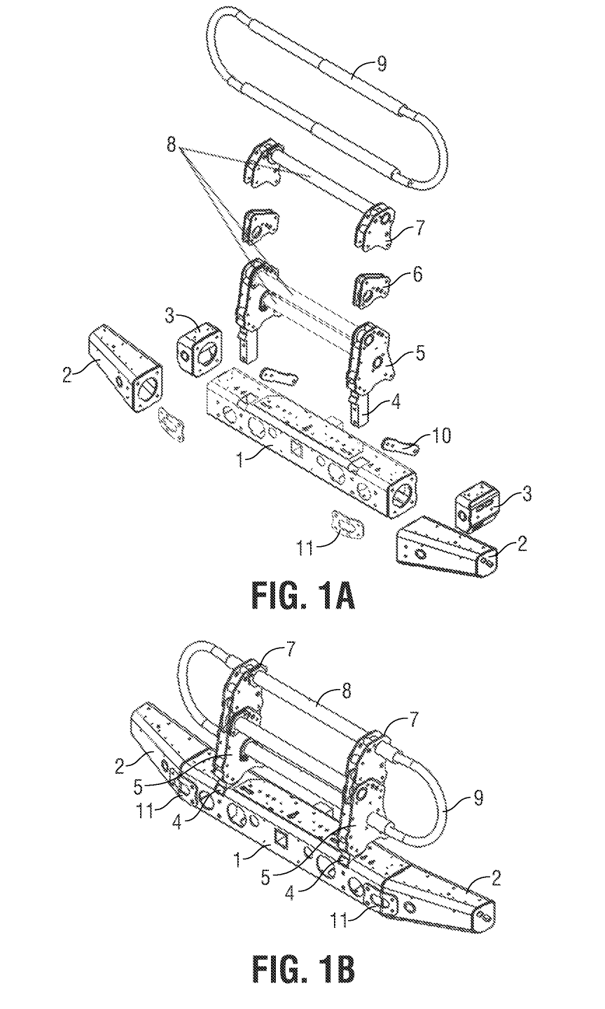

FIG. 1A illustrates an exploded perspective view of a modular front end system (“MFES”) in accordance with one or more embodiments of the present disclosure. The MFES includes a main bumper structure 1, outer bumper structures in both standard width outers 2 and stub width outers 3, upper bases 4, short upper plates 5, upper connector plates 6, full upper plates 7, one or more grill guards 8, headlight guards 9, tension/compression bars 10, and tension plates 11 used with the standard width outers 2. Additional spacers (not shown) may be used to connect the short upper plates 5, upper connector plates 6, and full upper plates 7. Components of the MFES may be constructed of aluminum, steel, or other metal materials such as, but not limited to titanium and beryllium. In yet other embodiments, components of the MFES may be constructed of ceramics. In still further embodiments, components of the MFES may be constructed from non-metallic composite materials.

The main bumper structure 1 may include a bumper body and end plates (which may serve as bulkheads or partitions between the outer sections attached to the main bumper structure). Bumper body may have a square or rectangular cross-section, which gives the bumper body a “box-like” shape. The bumper body may have a constant cross-sectional area along an entire length thereof, or alternatively may have a variable or tapered cross-sectional area along a length thereof. For example, in one embodiment, the bumper body may be tapered in one direction (i.e., toward distal ends of the bumper body). The bumper body and end plates may be constructed by cutting (e.g., laser, water jet, punch, etc.) and forming flat metal plate (e.g., brake, stamping, hydroforming, etc.). Flat plates may be welded together to form the bumper body, and end plates may be welded to the bumper body. The outer sections, both the standard width outers 2 and the stub width outers 3 may be constructed using the same steps as found in the construction of the main bumper structure 1. Outer sections, particularly the standard width outers 2, may have a rectangular or square cross-section which tapers in one direction (i.e., toward distal ends of the outer sections). Likewise, the short upper plates 5, upper connector plates 6, and full upper plates 7 may be constructed by cutting (e.g., laser, water jet, punch, stamping, etc.) the shapes from flat plate material, and subsequently assembled using one or more spacers between flat plates and one or more fasteners for assembly.

One or more tension/compression bars 10 may be used to join the short upper plates 5 to the vehicle frame (not shown). The tension/compression bars 10 may also be used when upper connector plates 6 and the full upper plates 7 are coupled with the short upper plates 5. The tension/compression bars 10 may be coupled between the short upper plates 5 and the vehicle frame in a manner that provides additional structural support by triangulating the short upper plates 5 to the main bumper structure 1 and vehicle frame. In the event of a collision, the tension/compression bars 10 may be configured to fail at a predetermined load level thereby preventing damage to the vehicle frame. For example, a width or cross-sectional area of the tension/compression bars 10 may be selected to withstand up to a certain amount of force (in either tension, or compression, or both tension and compression) before failure. One of ordinary skill in the art will understand said calculations given a particular material type, cross-sectional area, moment arms, and other parameters.

The headlight guards 9 may be constructed using a pair of formed tubes, which serves as the primary headlight guards, one for each side. Each headlight guard tube is joined to an upper and lower junction component. This junction component allows the headlight guard component to be joined to the grill guard component. Joining of these components may be through welding or fasteners. Headlight guards 9 may be configured as cantilevered ends which are joined to one or more of the short upper plates 5, upper connector plates 6, and full upper plates 7. The cantilevered ends of the headlight guards 9 may be designed to distribute the load of an impact or collision across the one or more of the short upper plates 5, upper connector plates 6 and full upper plates 7 in such a way as to not require welding in joining the various components. The grill guards 8 may be constructed by joining basic tube structures to flange structures by welding.

By using various components this structure may be assembled into multiple configurations (not shown). In an embodiment, for example, the bumper may be a base model comprising main bumper structure 1 and standard width outers 2, or a stub system comprising main bumper structure 1 and stub width outers 3. In addition each of these bumpers may be further configured to also include one or more of these additional components or combinations of these additional components: short upper plates 5 with one, two or more grill guards 8; full upper plates 7 with one, two or more grill guards 8; and headlight guard 9. Each of these configurations, moreover, can be joined with one or more of the other systems, components and assemblies described herein, including the gear-mount system, rotator shackle assembly, hi-lift shackle, and drop-pin assembly. All components may be joined using fasteners of various sizes, including but not limited to removable fasteners such as, without limitation, bolts and screws. For example, standard SAE grade fasteners, including but not limited to 8.8 spec metric fasteners or 10.9 spec metric fasteners, as well as others may be used. This allows for aluminum construction where welding will reduce the strength of high strength, heat treated aluminum alloys. The MFES may be used by selecting the desired configuration and then joining the various components using basic hand tools.

The main bumper structure may be assembled and fastened to a vehicle frame using fasteners of various sizes, including but not limited to removable fasteners such as, without limitation, bolts and screws. For example, standard SAE grade fasteners, including but not limited to 8.8 spec metric fasteners or 10.9 spec metric fasteners, as well as others may be used to join main bumper structure 1 to the vehicle frame. Preferably, the main bumper structure can be secured to the vehicle frame without any cutting, drilling, or other modification to the vehicle frame or otherwise. Advantageously, the ability to mount the bumper on the vehicle frame without drilling, cutting or otherwise modifying the vehicle frame diminishes the risk of voiding or otherwise negatively affecting coverage under any original equipment manufacturer warranty or other warranty relating to the vehicle or vehicle frame.

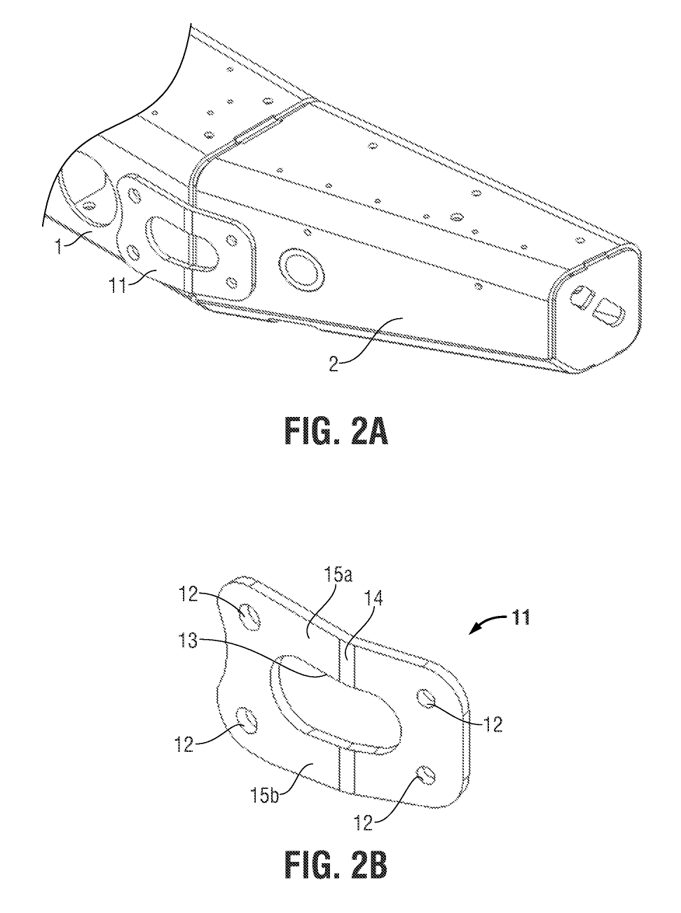

Referring now to FIGS. 2A and 2B, in certain embodiments, tension plates 11 may be used to join the standard width outers 2 to the main bumper structure 1 at one or more fastener holes 12. The tension plates 11 are configured to provide structural support at the junction of these components in the event of a collision. In addition, the tension plates 11 are configured to allow for a predetermined level of failure, which in the event of a collision, allows the standard outer components 2 to separate from the main bumper structure 1, and by doing so absorb energy in the collision. The tension plates may be constructed of aluminum, steel or other metal materials.

The tension plate 11 may be formed from flat plate material, which is then angled or bent at a crease 14 to fit contours of the main bumper structure 1 and standard width outers 2, as shown. Further, the tension plate 11 may be formed having an upper isthmus 15a and a lower isthmus 15b of a certain width formed by a centrally located opening 13 in the tension plate. Cross-sectional areas of the upper isthmus 15a and lower isthmus 15b are sized to withstand forces up to a particular amount, after which the upper isthmus 15a and lower isthmus 15b fail allowing the standard outer components 2 to tear away from the main bumper structure 1. For example, to allow for failure of the tension plates at X pounds of force, the upper isthmus 15a and lower isthmus 15b may have a cross-sectional area of Y inches by Z inches. Those skilled in the art will understand specific requirements for sizing the upper and lower isthmuses given certain material properties, moment arms and other considerations. What's more, in certain embodiments, cross-sectional areas of the upper isthmus 15a and lower isthmus 15b may be equal, or close to equal. In other embodiments, cross-sectional areas of the upper isthmus 15a and lower isthmus 15b may be unequal. For example, a cross-sectional area of the upper isthmus 15a may be greater than a cross-sectional area of the lower isthmus 15b, or vice versa, by varying either widths or thicknesses, or both. In yet other embodiments, the tension plate 11 may be formed having more than two isthmuses.

Those skilled in the art will further appreciate and understand varying the cross-sectional area of the upper and lower isthmuses to configure the tension plate to withstand less or more force during a collision before failure. In this way, the tension plates 11 may be customized for specific applications depending on vehicle use. Other structural characteristics of the tension plate may be varied to customize the maximum force that may be withstood, including but not limited to, increasing or decreasing the thickness of the tension plate, varying the size or shape of the opening 13 in tension plate 11, or using more than one tension plate to couple the standard width outers 2 to the main bumper structure 1 (e.g., doubling the maximum force by doubling the number of tension plates used).

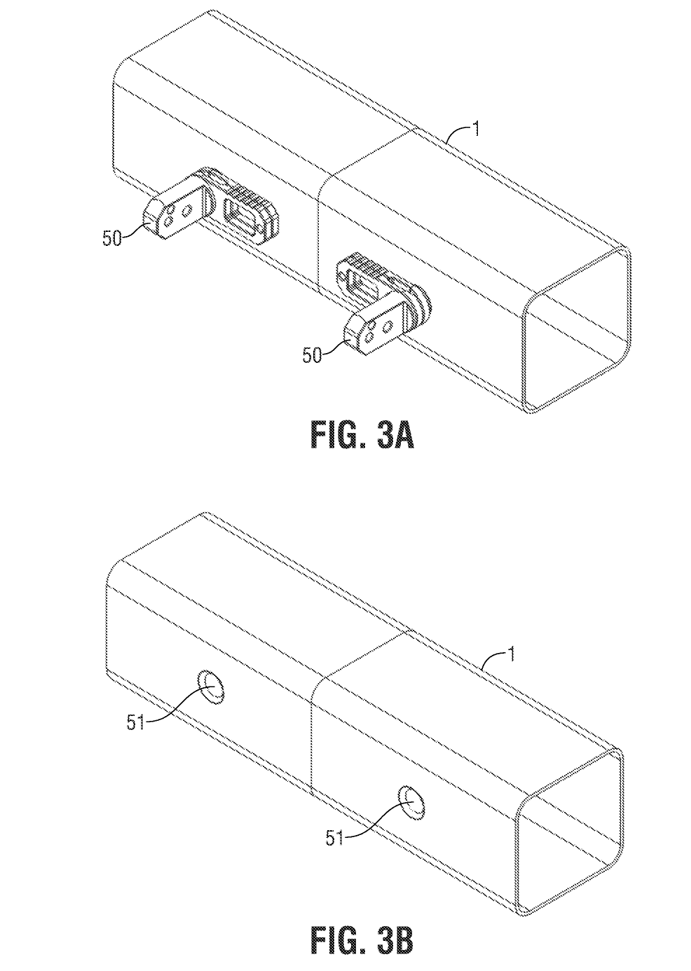

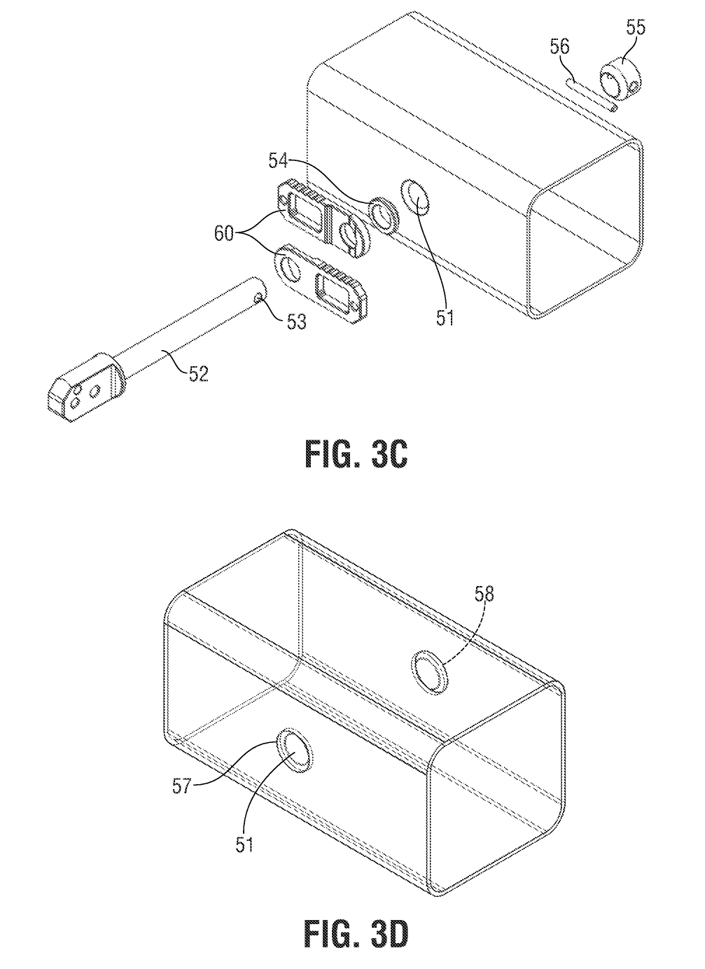

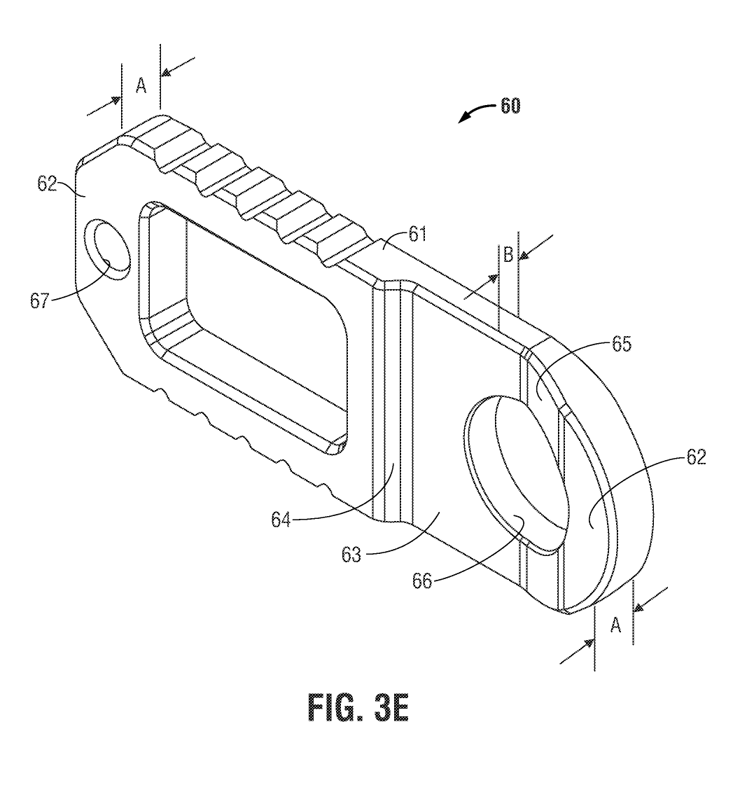

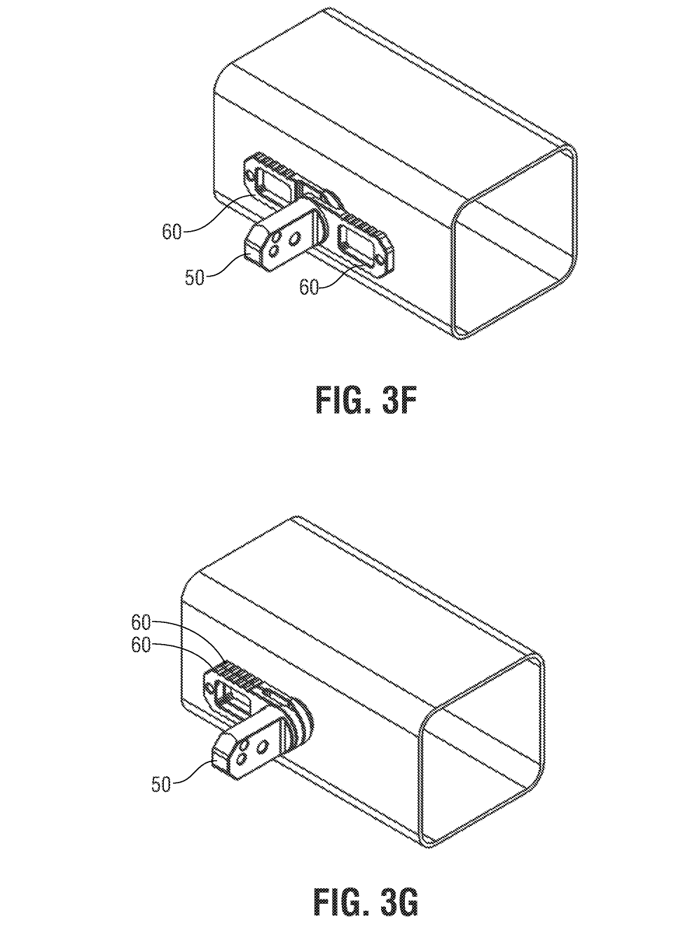

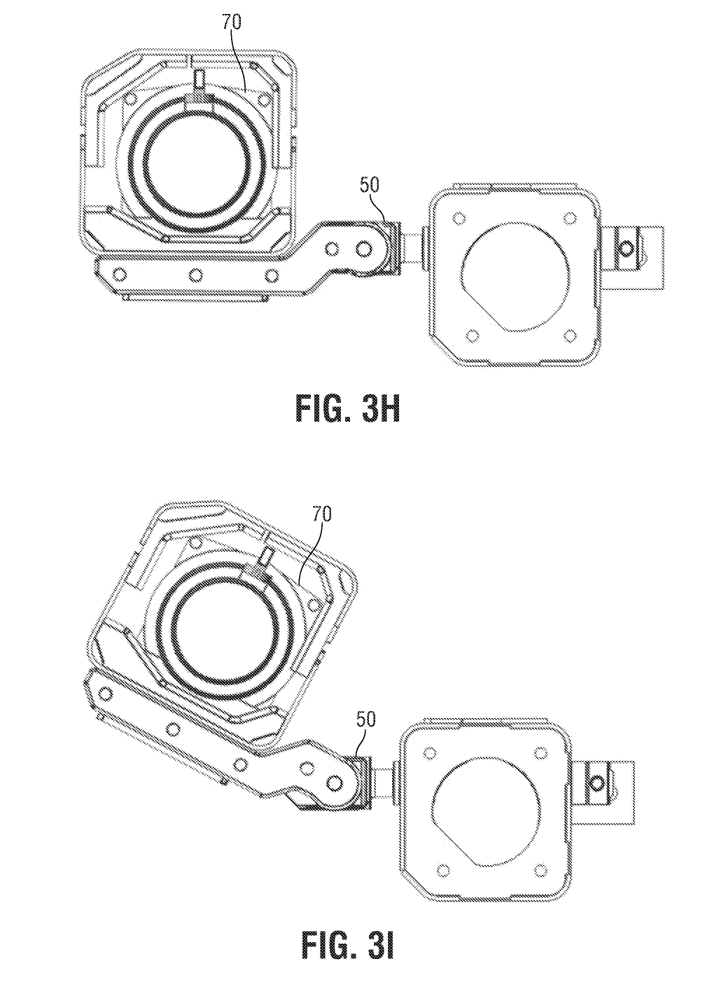

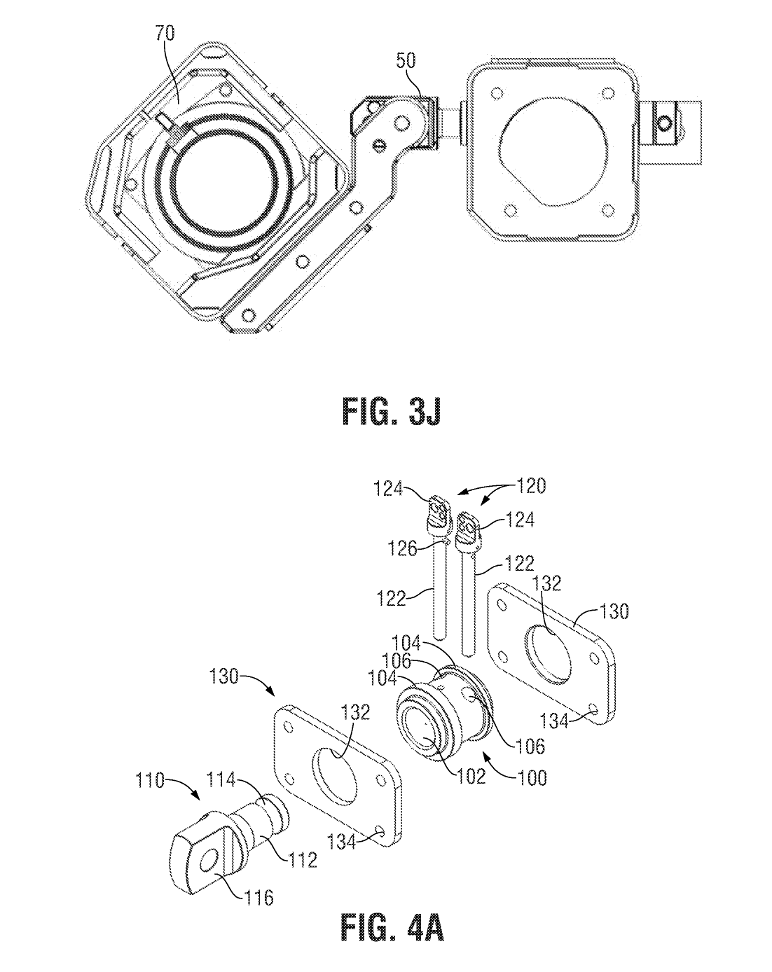

Referring to FIGS. 3A-3D, perspective views of a gear mount system in accordance with one or more embodiments of the present disclosure are shown. The gear mount system includes a pair of mounting leg assemblies 50 coupled to a vehicle bumper 1 at corresponding mounting points 51 (e.g., mounting holes). FIG. 3C illustrates components of a mounting leg assembly 50, which includes a mounting leg 52, a front male mounting cone 54, a rear male mounting cone 55, a retaining pin 56 and tensioners 60. FIG. 3D illustrates components of a mounting point 51, which include a front female mounting cone 57 and a rear female mounting cone 58. The front and rear female mounting cones 57, 58 are placed between the front male mounting cone 56 and the rear male mounting cone 58 of the mounting leg assembly 50. The mounting cones are formed having corresponding tapered surfaces.

All components may be machined from suitable material such as, but not limited to aluminum, steel, titanium and beryllium. In yet other embodiments, components of the MFES may be constructed of ceramics. In still further embodiments, components of the MFES may be constructed from non-metallic composite materials. Material selection may be dependent upon cargo load requirements, assembly weight requirements, environmental concerns of corrosion and/or temperature and other requirements as will be understood by one of ordinary skill in the art. In addition, all components may be coated if required for corrosion protection. For example, in certain embodiments a three-step coating process may be used for coating components. First, components may be dipped or submerged in an alodine bath, or similar chromate conversion coating. Next, components may have a powder coating applied (after removal from the alodine bath). Last, fasteners may be coated with a final coating of GeoBlack® or MagnaGuard®. One skilled in the art will understand coating thicknesses, a particular order in which coatings are to be applied, number of coatings, curing times, and other specifics of the coating process.

FIG. 3E illustrates a tensioner 60 in greater detail. The tensioner 60 includes a first hole 66 through which the mounting leg 52 (FIG. 3C) may be inserted, and a second hole 67 at an opposite end, which is described in greater detail below. Combining two tensioners 60 in a certain manner (described below in greater detail) serves to tension the mounting leg assembly and removes any free play resulting in a much stronger mounting structure. Particularly, the ‘tensioning’ functionality provided by the tensioners 60 is accomplished by arranging one or more recessed surfaces 63 of the tensioners 60 in a certain manner, described in more detail below. As shown, the tensioner 60 component is formed having a first substantially planar surface 61 and an opposite second substantially planar surface 62. A first width ‘A’ exists between the first planar surface 61 and second planar surface 62.

The tensioner 60 is further formed having a recessed surface 63. A first angled or beveled surface 64 extends between the second planar surface 62 and a first edge of the recessed surface 63, and a second angled or beveled surface 65 extends between a second edge of the recessed surface 63 and the second planar surface 62. A second width ‘B’ exists between the first planar surface 61 and the recessed surface 63. Second width ‘B’ is less than the first width ‘A.’

When two tensioners 60 are combined (i.e., stacked together) in an ‘unlocked’ rotated position (180° opposed) as shown in FIG. 3F, the recessed surface 63 of one tensioner 60 contacts the second planar surface 62 of the other tensioner 60, and vice versa. Thus, a total thickness of the combined tensioners 60 is an amount twice the width ‘B’ between the first planar surface 61 and the recessed surface 63 (e.g., 2B).

When the tensioners 60 are rotated from their opposed positions into aligned or ‘locked’ positions (FIG. 3G), the second planar surfaces 62 of the two tensioner 60 move into contact, thereby increasing the total width of the combined tensioners 60 and tensioning the mounting leg assemblies 50. The gear mount system is designed to be placed into tension against the front and rear male mounting cones 54, 55 and the front and rear female mounting cones 57, 58 by rotating the tensioners 60 into alignment with each other. This action removes or takes up additional space in the assembly, placing the assembly under tension and removing any free play from the structure. In other words, the additional space is removed by increasing the total thickness of the combined tensioners 60 to an amount twice the width ‘A’ between the first planar surface 61 and the second planar surface 62 (e.g., 2A). Therefore, the ‘tensioning’ function takes up the difference between width 2A and width 2B.

Referencing FIGS. 3C, 3D, 3F and 3G, assembly of the gear mount system begins by installing front and rear female mounting cones 57, 58 into mounting points 51, aligning holes 66 of tensioners 60 and the front male mounting cone 54, and inserting the mounting leg 52 there through. Initially, the tensioners 60 are in an unlocked position. The rear male mounting cone 55 is then installed and the retainer pin 56 is inserted into hole 53 in an end of the mounting leg 52. FIG. 3F illustrates the fully installed and fitted (but un-tensioned) mounting leg assembly 50. The same process may be repeated for assembling additional mounting leg assemblies 50. To complete the installation process the user then rotates the tensioners 60 from unlocked opposed positions (FIG. 3F) into their locked and aligned position (FIG. 3G), which tensions the assembly and removes any free play resulting in a much stronger mounting structure. Furthermore, a pin (not shown) or similar device may be inserted into aligned pin holes 67 of the tensioners 60 to prevent the tensioners 60 from becoming unaligned and unlocking, thereby losing tension in the mounting leg assembly 50. Removal of the mounting leg assembly 50 is accomplished in reverse order from installation, as will be understood by one of ordinary skill in the art.

Accessories may be attached to the mounting legs 50, which may be performed either before or after mounting legs have been installed. Tensioners may be moved to their unlocked positions to allow for proper alignment of the mounting legs to any accessories attached thereto. In one example, trays or extensions of various sizes may be attached to the mounting legs. The trays may carry one or more containers, such as toolboxes or storage containers. In another example, as shown in FIGS. 3H-3J, a winch 70 may be attached to the mounting legs 50 in certain embodiments. As shown, the winch 70 is allowed to pivot in plane with a pulling load on the winch line. When the winch is not in use, it may be stowed in a 30 degree ‘up’ position (FIG. 31) for travel, or simply removed from the front bumper quickly using the gear mount system. Alternatively, the winch 70 is allowed to pivot downward (FIG. 3J). In certain embodiments, the winch 70 may be allowed to pivot upward and downward by up to about 30 degrees from a neutral horizontal position. In yet other embodiments, the winch 70 may be allowed to pivot upward and downward by up to about 45 degrees from a horizontal position.

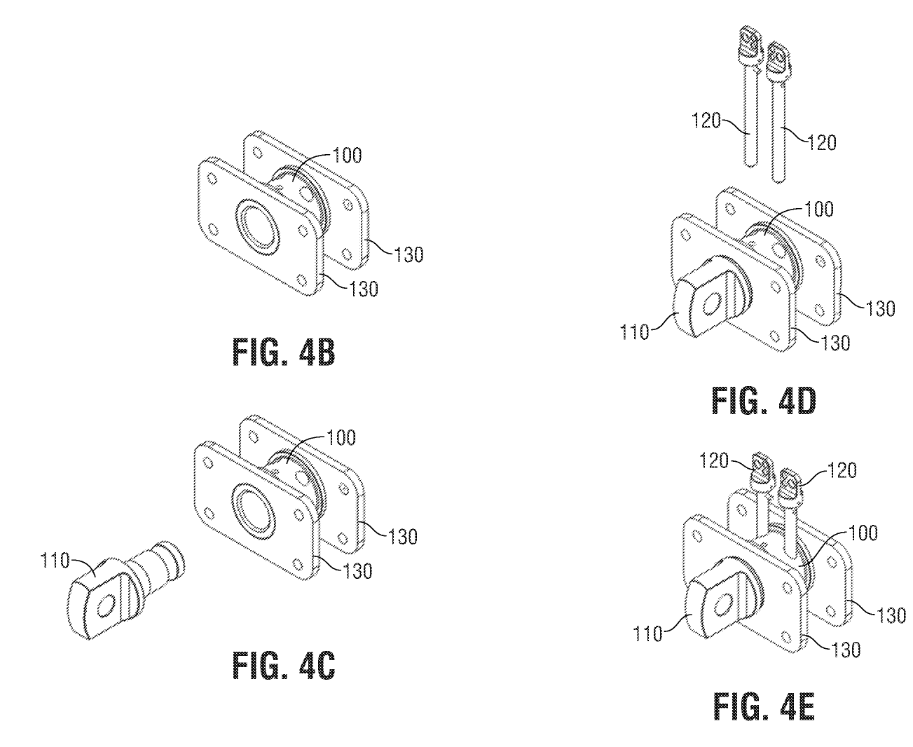

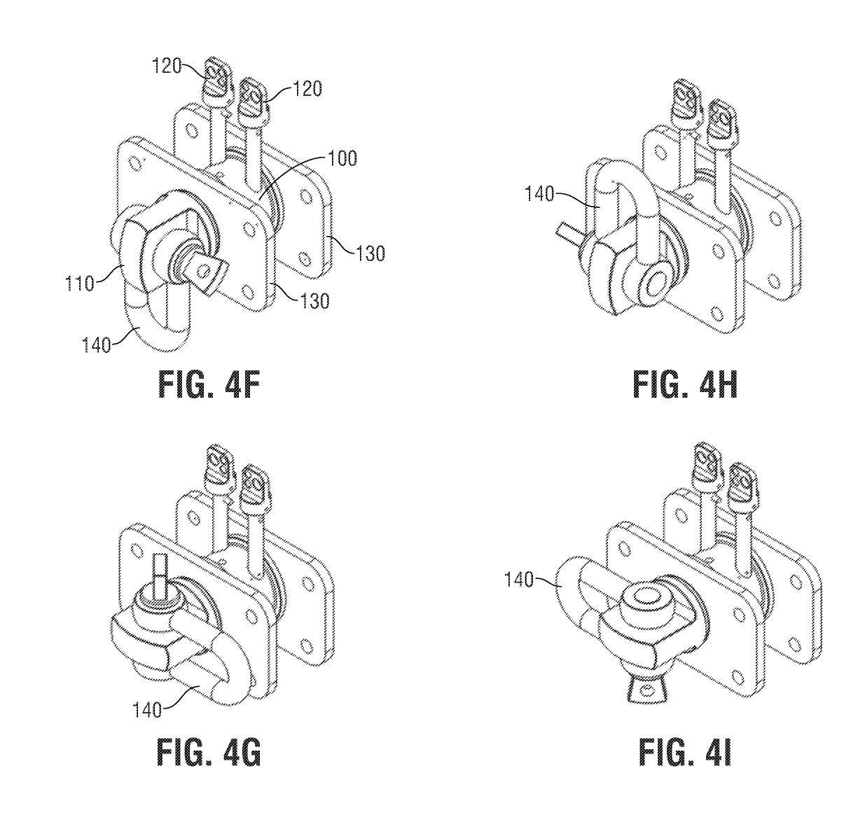

FIG. 4A illustrates an exploded perspective view of a rotator shackle assembly in accordance with one or more embodiments of the present disclosure. One or more embodiments disclosed herein provides for functionality that eliminates inherent weaknesses found in standard recovery shackles. The rotator shackle assembly includes a rotator sleeve 100, a rotator pin 110, retainer pins 120, and locater plates 130. Components of the rotator shackle assembly may be machined (e.g., laser or water jet) from a single piece of suitable material, such as aluminum, steel, or other metals such as, but not limited to titanium and beryllium. In yet other embodiments, components of the MFES may be constructed of ceramics. In still further embodiments, components of the MFES may be constructed from non-metallic composite materials.

The rotator sleeve 100 is a generally cylindrical component having a central axial bore 102 there through. The rotator sleeve 100 is formed having annular flanges 104 on both ends. The annular flanges 104 are configured to abut locater plates 130. Further, the rotator sleeve 100 includes at least one passageway 106 that extends through a diameter of the rotator sleeve 100 in a direction perpendicular to axial bore 102. As shown, the rotator sleeve 100 includes two passageways 106, although more than two may be contemplated.

The rotator pin 110 is formed having a generally cylindrical stem portion 112 that extends from a head portion 116. The stem portion 112 has an outer diameter sized to correspond with an inner diameter of the central bore 102 of the rotator sleeve 100. Further, a recess or groove 114 extends circumferentially about and proximate to a distal end of the stem portion 112. The circumferential groove 114 has a generally circular or semi-circular cross-section, although non-circular cross-sections may also be contemplated. The circumferential groove 114 is sized to correspond with the inner diameter of passageways 106 extending through the rotator sleeve 100.

The retainer pin 120 includes a generally cylindrical stem portion 122 which extends from a head portion 124. The outer diameter of the stem portion 122 is sized to correspond with an inner diameter of the passageways 106 extending through the rotator sleeve 100 and the circumferential groove 114 of the rotator pin 110. The retainer pin 120 further includes a small extension 126 extending perpendicular to a central axis through the stem portion 122. The extension 126 may be used to align with a small groove or cutout (not shown) that is located on the perimeter of a hole in a vehicle frame, bumper or other structure when the retainer pin is inserted there through. When the retainer pin 120 is rotated and the extension 126 is moved out of alignment with the small cutout, the extension 126 prevents the retainer pin 120 from being removed from the vehicle frame or bumper, as will be understood by one of ordinary skill in the art.

The locater plates 130 are flat plates having a central hole 132 there through and sized to correspond with an outer diameter of the rotator sleeve 100. As previously described, annular flanges 104 of the rotator sleeve 100 abut the locater plates 130. In addition, one or more holes 134 may be formed in the locater plates 130 through which fasteners may be inserted for securing or coupling the locater plates 130 to a vehicle frame or bumper (not shown).

FIGS. 4B-4E illustrate steps in assembling the rotator shackle assembly. The rotator sleeve 100 and locator plates 130 are joined to form an assembly (FIG. 4B). The rotator pin 110 is then inserted into said assembly (FIG. 4C). This assembly is mounted to the vehicle frame or bumper. With the rotator pin 110 installed, the retainer pins 120 are inserted into the rotator sleeve 100 to secure the rotator pin 110 within the rotator sleeve 100 (FIG. 4E). In certain embodiments, only one retainer pin 120 may be inserted to secure the rotator pin 110 within the rotator sleeve 100.

FIGS. 4F-4I illustrate a recovery shackle 140 installed onto the rotator shackle assembly and different positions of said recovery shackle 140. The recovery shackle 140 may be coupled to a head portion of the rotator pin 110 using pins or other fastening devices known to one of ordinary skill in the art. The rotator shackle assembly is used by installing the recovery shackle 140 on the rotator pin 110. Installation of the recovery shackle 140 may be made with the rotator pin 110 installed or removed from the rotator sleeve 100. Once the rotator shackle assembly is fully assembled (see FIGS. 4B-4E), a recovery device (not shown) (e.g., a chain or pull strap) is attached to the recovery shackle 140 and the recovery may begin.

With the rotator pin 110 installed and secured within the rotator sleeve 100 by the retainer pins 120, the rotator pin 110 may rotate freely 360 degrees around its longitudinal axis, allowing the recovery shackle 140 to freely rotate and assume the strongest recovery angle in line with the recovery loads. For example, as shown, the recovery shackle 140 may rotate downward (FIG. 4F), to the right (FIG. 4G), up (FIG. 4H), to the left (FIG. 4I), and any other 360 degree orientation. The recovery shackle 140 may also rotate around its pin axis (i.e., the pin coupling the recovery shackle with the rotator pin) providing additional alignment with the recovery loads. This reduces any risk of improperly loading the recovery shackle during the recovery operation.

Therefore, embodiments disclosed herein relate to a recovery shackle allowed to rotate freely to any position, keeping the primary recovery load in a perpendicular axis to the recovery shackle pin. In addition, the recovery shackles are easily removed and installed.

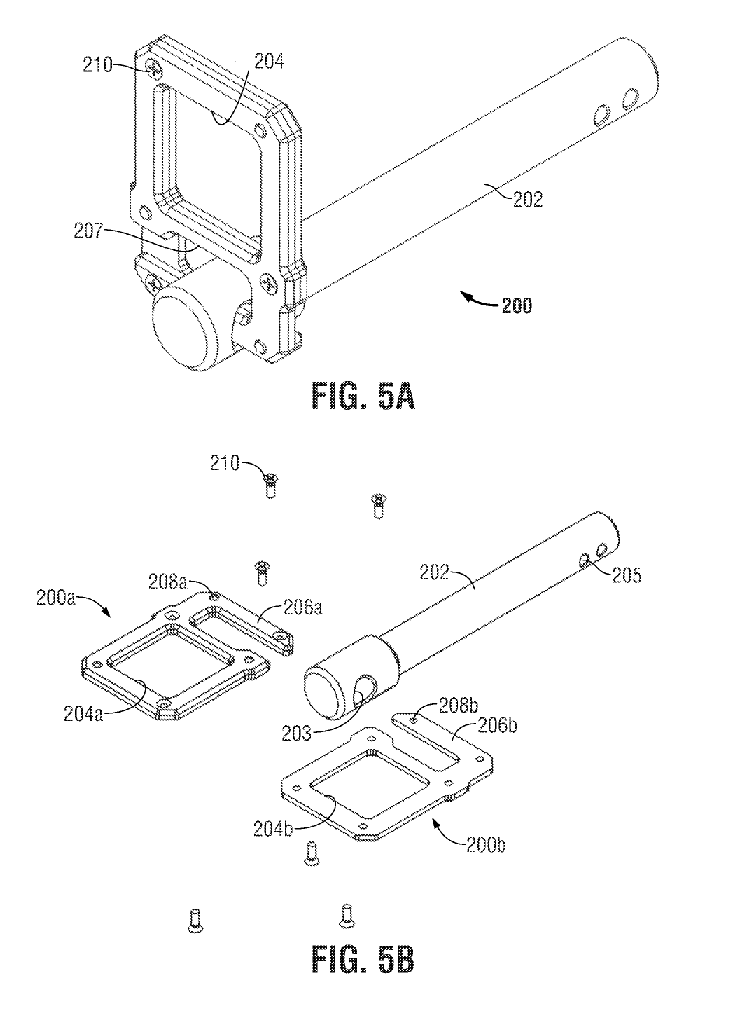

FIGS. 5A and 5B illustrate a hi-lift shackle assembly in accordance with one or more embodiments of the present disclosure. The hi-lift shackle includes a shackle 200 coupled with a pin 202, which is inserted into a vehicle at various frame or bumper points and secured with a standard retainer pin (e.g., a cotter pin). The hi-lift shackle allows the user to capture the tongue of a hi-lift jack (not shown) securely, thereby eliminating the danger of the hi-lift jack sliding free of its purchase (i.e., the point where the hi-lift jack contacts the vehicle). The shackle may rotate upward and downward in a vertical plane and also rotate around an axis of the pin 202, thereby allowing the hi-lift jack and vehicle to remain securely joined and removing the risk of the hi-lift jack slipping free.

FIG. 5B illustrates an exploded view of the shackle. The shackle is constructed of two shackle plates 200a and 200b, which in certain embodiments may be identical. The shackle plates may be formed from a flat plate and may be aluminum, steel, or other metals such as, but not limited to titanium and beryllium. In yet other embodiments, components of the MFES may be constructed of ceramics. In still further embodiments, components of the MFES may be constructed from non-metallic composite materials. For example, the shackle plates may be cut from metal plate (e.g., laser, water jet, punch, etc.) and machined to final configuration adding fastener holes 208 and threading. The shackle pin 202 may be lathe cut. The shackle plates have a first cutout 204 into which the tongue of a hi-lift jack is inserted. The shackle plates are further formed having a tongue or extension 206 which are inserted into a hole 203 in the shackle pin 202. What's more, the tongue 206a of the first shackle plate 200a may be inserted into hole 203 from a first direction, while the tongue 206b of the second shackle plate 200b may be inserted into hole 203 from the opposite direction, thereby forming an enclosed second cutout 207 there within. The shackle plates 200a and 200b are then coupled together with fasteners 210 for aluminum construction, or in other embodiments, welded for steel construction, or in other embodiments using any means known to a person of ordinary skill in the art.

The hi-lift shackle is used by inserting the hi-lift shackle assembly into the vehicle bumper or frame and is then secured from the backside of the bumper or frame by a standard retainer pin (e.g., inserting a cotter pin through one or more holes 205 in shackle pin 202). The hi-lift jack device is then positioned relative to the vehicle and the jack tongue is inserted into the first cutout 204 of the shackle plate 200, with the shackle plate rotated into the vertical position as shown in FIG. 5A. The user checks the footing of the hi-lift jack, then proceeds to raise the vehicle with the hi-lift jack. Tension is applied to the shackle plate by engaging the hi-lift jack lifting mechanism. When the vehicle maintenance or recovery is complete the user lowers the jack and removes the jack tongue from the shackle plate. In certain embodiments, the hi-lift shackle may be left installed in the bumper or frame, or alternatively it may be removed at this point.

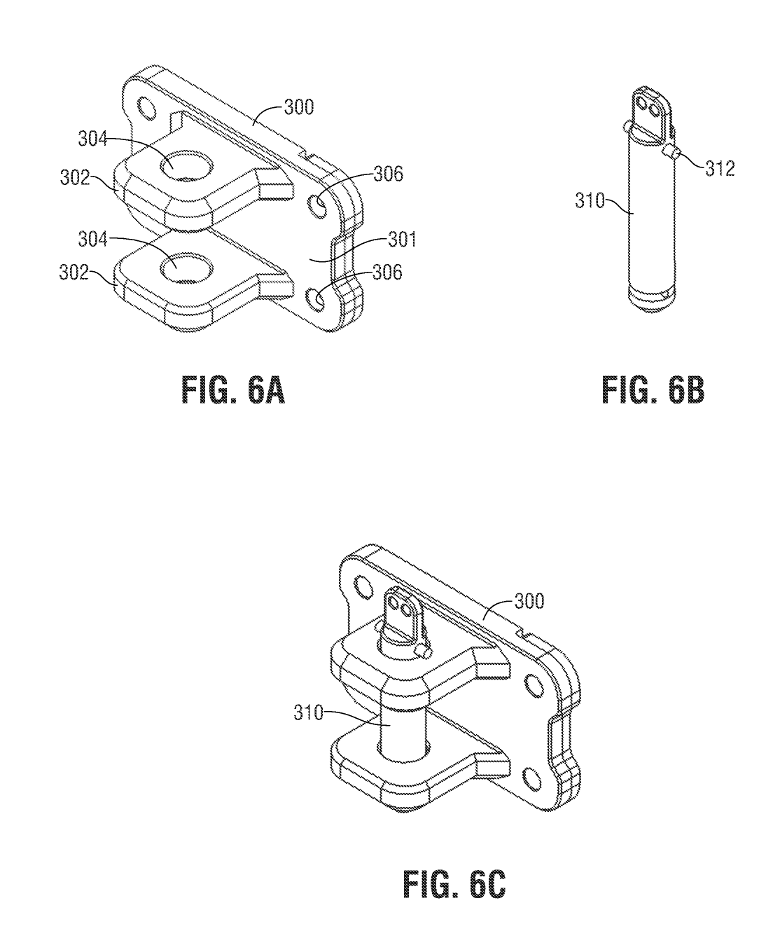

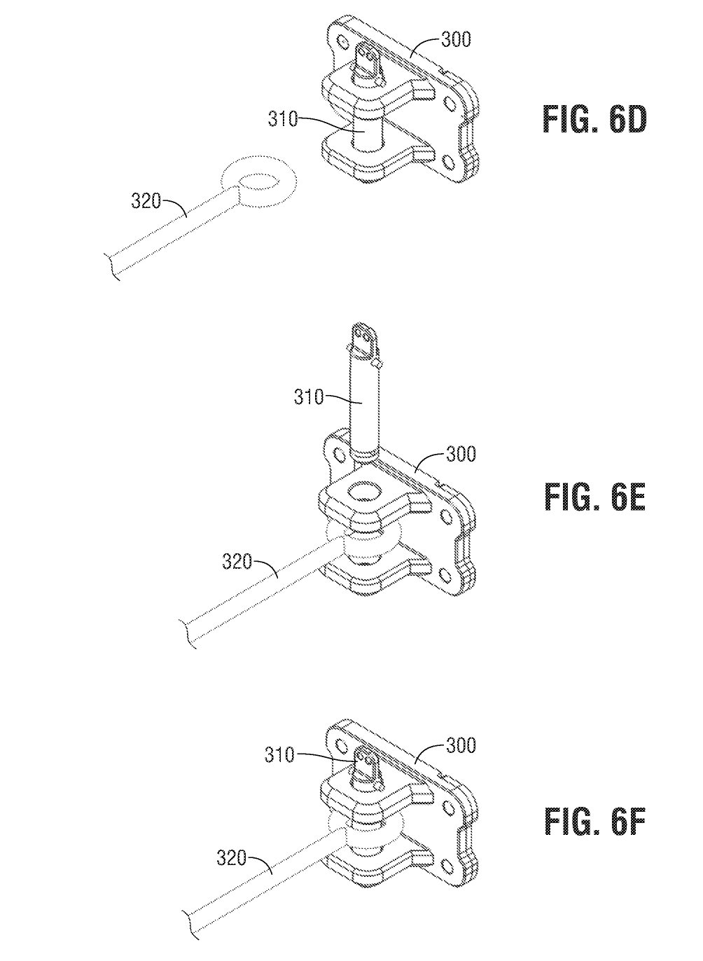

FIGS. 6A-6C illustrate a drop pin jaw assembly in accordance with one or more embodiments of the present disclosure. The drop pin jaw includes a drop pin jaw 300 (FIG. 6A), which is attached to a vehicle (not shown), and a pin 310 (FIG. 6B), which is inserted into the drop pin jaw 300 and secured by a standard retainer device (not shown) (e.g., a cotter pin) (FIG. 6C). The drop pin jaw assembly allows a user to securely capture a recovery device (e.g., a chain or recovery strap) securely and quickly.

The drop pin jaw 300 is constructed of a machined block of material, such as aluminum, steel or other metal such as, but not limited to titanium and beryllium. In yet other embodiments, components of the MFES may be constructed of ceramics. In still further embodiments, components of the MFES may be constructed from non-metallic composite materials. The drop pin jaw includes two extruded tongue portions 302 extending from a base plate 301. In other embodiments, more than two extruded tongue portions may be contemplated for additional strength or alignment. One or more generally circular holes 306 are formed in the base plate 301 through which fasteners (not shown) may be inserted for securing the drop pin jaw 300 to a vehicle. Further, centrally located generally circular holes 304 are formed in the tongues 302 through which the pin 310 is inserted. The holes 304 in the tongues 302 are aligned.

The pin 310 is a generally cylindrical machined shaft having an outer diameter sized to correspond with inner diameters of said holes 304 in tongues 302 of the drop pin jaw 300. The pin 310 includes a secondary pin 312 inserted perpendicularly into the shaft to provide a positive perch to prevent the pin from falling through the holes 304 in said drop pin jaw 300.

FIGS. 6D-6F illustrate steps in securing a recovery device 320 to the drop pin jaw assembly. The pin 310 generally remains installed within the drop pin jaw 300 (FIG. 6D). The drop pin jaw assembly is used by removing the standard retainer device (e.g., cotter pin) from the pin 310 and then removing the pin 310 from the drop pin jaw 300. The recovery device 320 (e.g., a recovery strap, shackle or winch cable) is then placed in the jaw of the drop pin jaw 300 (FIG. 6E). With the recovery device 320 properly positioned in the drop pin jaw 300, the pin 310 is reinserted into the drop pin jaw 300, thereby securing the recovery device 320, and the standard retainer device is reinstalled locking the pin 310 in position (FIG. 6F). After completion of the recovery of the vehicle, the recovery device 320 may be removed in the reverse sequence from installation.

Although embodiments of the present invention have been described in detail, it will be apparent to those skilled in the art that many embodiments taking a variety of specific forms and reflecting changes, substitutions and alterations can be made without departing from the spirit and scope of the invention. The described embodiments illustrate the scope of the claims but do not restrict the scope of the claims.

What is claimed is:

1. A modular front end system comprising:
a main bumper structure;
outer bumper structures disposed on either end of the main bumper structure; and
tension plates disposed at junctions between the main bumper structure and each of the outer bumper structures and supportably coupling each outer bumper structure to the main bumper structure, wherein each tension plate is configured to fail before the main bumper structure and the outer bumper structures in the event of a collision.

2. The system of claim 1, wherein the tension plate comprises an upper isthmus and a lower isthmus having a predetermined width, and a centrally located opening therebetween.

3. The system of claim 2, wherein widths of the upper isthmus and lower isthmus are determined according to a desired failure load for the tension plate.

4. The system of claim 1, wherein the main bumper structure is fastened to a vehicle frame without modification of the vehicle frame.

5. The system of claim 1, further comprising a plurality of upper plates having one or more grill guards extending therebetween and coupled to the main bumper with one or more tension and compression bars.

6. The system of claim 5, further comprising a plurality of connector plates configured to couple together any combination of the plurality of upper plates.

7. The system of claim 6, further comprising a headlight guard configured as cantilevered ends which are joined to the plurality of upper plates, wherein the cantilevered ends of the headlight guards are configured to distribute impact loads during a collision across the plurality of upper plates and connector plates.

8. The system of claim 1, further comprising one or more components coupled directly or indirectly to the main bumper by a plurality of fasteners.

9. The system of claim 1, further comprising a gear mount system including a pair of mounting leg assemblies coupled to the main or outer bumper structures, each mounting leg assembly comprising:
a mounting leg inserted into at least one mounting point in the main or outer bumper structures;
a plurality of tensioners each having a hole through which the mounting leg is inserted, wherein each tensioner comprises a first width defined between a first planar surface and a second planar surface, and a second width defined between the first planar surface and a recessed surface, wherein the first width is greater than the second width; and
a retaining pin configured to be inserted at an end of the mounting leg, wherein after the retaining pin is inserted, the plurality of tensioners are configured to be rotated about an axis of the mounting leg to abut the second planar surfaces of the plurality of tensioners and impart tension on the mounting leg.

10. The system of claim 9, further comprising a front male mounting cone and a rear male mounting cone.

11. The system of claim 9, further comprising a front female mounting cone and a rear female mounting cone.

12. The system of claim 1, further comprising a rotator shackle assembly coupled to the main or outer bumper structures, the shackle assembly comprising:
one or more locater plates having a central hole and coupled to the main or outer bumper structures;
a rotator sleeve having a central axial bore, annular flanges on both ends configured to abut the locater plates, and a passageway extending through a diameter of the rotator sleeve in a direction perpendicular to the axial bore;
a rotator pin having a generally cylindrical stem portion extending from a head portion, and a groove extending circumferentially about the stem portion, wherein the rotator pin is inserted into the axial bore until the circumferential groove is substantially aligned with the passageway in the rotator sleeve; and
a retainer pin having a generally cylindrical stem portion extending from a head portion, wherein the retainer pin is inserted into the passageway of the rotator sleeve and engages the circumferential groove of the rotator pin.

13. The system of claim 1, further comprising a hi-lift shackle assembly coupled to the main or outer bumper structures, the hi-lift shackle assembly comprising:
a pin configured to be inserted into a corresponding receptacle in the main bumper or outer bumper structures; and
at least two shackle plates comprising tongues inserted in opposite directions through the pin, wherein the at least two shackle plates are coupled together.

14. A vehicular front end system comprising:
a main bumper and separate modular outer bumper components;
one or more tension plates configured to supportably couple the modular outer bumper components to the main bumper, wherein the tension plates are configured to fail before the main bumper and modular outer bumper components in the event of a collision;
a plurality of modular plate components coupled to the main bumper having one or more grill guards extending therebetween; and
headlight guards configured as cantilevered ends which are joined to the modular plate components, wherein the cantilevered ends of the headlight guards are configured to distribute impact loads during a collision across the modular plate components.

15. The system of claim 14, wherein the tension plate comprises an upper isthmus and a lower isthmus having a cross-sectional area configured to withstand less force than a cross-sectional area of the main and outer bumper components.

16. The system of claim 14, wherein the tension plates are configured to fail completely prior to the main bumper and modular outer bumper components.

17. The system of claim 14, wherein the main bumper and modular outer bumper components comprise a first material, and the tension plates comprise a second material, the second material configured to fail before the first material under impact of a force.

18. The system of claim 14, further comprising a plurality of connector plates configured to couple together any combination of the plurality of modular upper plates.

19. The system of claim 14, further comprising a gear mount system including a pair of mounting leg assemblies coupled to the main or outer bumper components, each mounting leg assembly comprising:
a mounting leg inserted into at least one mounting point in the main or outer bumper structures;
a plurality of tensioners each having a first width defined between a first planar surface and a second planar surface, and a second width defined between the first planar surface and a recessed surface, wherein the first width is greater than the second width; and
a retaining pin, wherein rotating the plurality of tensioners and abutting the second planar surfaces of the plurality of tensioners tensions the mounting leg against the retaining pin inserted within an end of the mounting leg.

20. The system of claim 19, further comprising a front male mounting cone and a rear male mounting cone.

21. The system of claim 19, further comprising a front female mounting cone and a rear female mounting cone.

22. The system of claim 14, further comprising a rotator shackle assembly coupled to the main or outer bumper components, the shackle assembly comprising:
one or more locater plates having a central hole and coupled to the main or outer bumper components;
a rotator sleeve having a central axial bore, annular flanges on both ends configured to abut the locater plates, and a passageway extending through a diameter of the rotator sleeve in a direction perpendicular to the axial bore;
a rotator pin having a generally cylindrical stem portion extending from a head portion, and a groove extending circumferentially about the stem portion, wherein the rotator pin is inserted into the axial bore until the circumferential groove is substantially aligned with the passageway in the rotator sleeve; and
a retainer pin having a generally cylindrical stem portion extending from a head portion, wherein the retainer pin is inserted into the passageway of the rotator sleeve and engages the circumferential groove of the rotator pin.

23. The system of claim 14, further comprising a hi-lift shackle assembly coupled to the main or outer bumper components, the hi-lift shackle assembly comprising:
a pin configured to be inserted into a corresponding receptacle in the main bumper or outer bumper structures; and
at least two shackle plates comprising tongues inserted in opposite directions through the pin, wherein the at least two shackle plates are coupled together.

24. A gear mount system comprising:
a mounting leg inserted into at least one mounting point in a vehicle or bumper;
a plurality of tensioners each having a hole through which the mounting leg is inserted, wherein each tensioner comprises a first width defined between a first planar surface and a second planar surface, and a second width defined between the first planar surface and a recessed surface, wherein the first width is greater than the second width; and
a retaining pin configured to be inserted at an end of the mounting leg, wherein after the retaining pin is inserted, the plurality of tensioners are configured to be rotated about an axis of the mounting leg to abut the second planar surfaces of the plurality of tensioners and impart tension on the mounting leg.

25. The gear mount system of claim 24, further comprising a front male mounting cone and a rear male mounting cone.

26. The gear mount system of claim 24, further comprising a front female mounting cone and a rear female mounting cone.

27. The gear mount system of claim 24, wherein the bumper is a modular front end system.

28. The gear mount system of claim 24, wherein the plurality of tensioners are each rotated 180 degrees to tension the mounting leg.

29. The gear mount system of claim 24, further comprising a winch attached to one or more mounting legs and configured to pivot in plane with a pulling load on a winch line.

30. The gear mount system of claim 29, wherein the winch is configured to pivot in plane with the pulling load on the winch line up to 45 degrees from a horizontal position.

31. A rotator shackle assembly comprising:
a rotator sleeve having a central axial bore, annular flanges on both ends, and a passageway extending through a diameter of the rotator sleeve in a direction perpendicular to the axial bore;
a rotator pin having a generally cylindrical stem portion extending from a head portion, and a groove extending circumferentially about the stem portion;
a retainer pin having a generally cylindrical stem portion extending from a head portion;
wherein the rotator pin is inserted into the axial bore until the circumferential groove is substantially aligned with the passageway in the rotator sleeve, and
wherein the retainer pin is inserted into the passageway of the rotator sleeve and engages the circumferential groove of the rotator pin.

32. The shackle assembly of claim 31, further comprising locater plates coupled to a modular front end system.

33. A hi-lift shackle comprising:
a pin configured to be inserted into a corresponding receptacle in the main bumper or outer bumper structures; and
at least two shackle plates comprising tongues inserted in opposite directions through the pin, wherein the at least two shackle plates are coupled together.

34. The hi-lift shackle of claim 33, wherein the main bumper is a modular front end system.
